(19) United States
(12) Patent Application Publication
(10) Pub. No.: US 2015/0134756 A1
(43) Pub. Date: May 14, 2015

(54) System and Method for Real Time Bidirectional Threaded Messaging with Persistent Record Keeping

(71) Applicant: Jeff Willis, Burbank, CA (US)

(72) Inventor: Jeff Willis, Burbank, CA (US)

(21) Appl. No.: 14/488,201

(22) Filed: Sep. 16, 2014

Related U.S. Application Data
(60) Provisional application No. 61/880,092, filed on Sep. 19, 2013.

(51) Int. Cl. H04L 12/58

(52) U.S. Cl. CPC H04L 51/046; H04L 51/02; H04L 51/14
USPC 709/206

(57) ABSTRACT

A system and method for real time, bidirectional threaded messaging with persistent record keeping is presented. The invention pertains to environments where record-keeping is desired (e.g., emergency services dispatching, customer service,), and where clients employ common messaging technologies (e.g., SMS or MMS messaging, e-mails). The system disclosed includes a method for threading messages regardless of what type of message it may be, and it includes a method to auto-forward messages to appropriate agencies needed to take action on any given message or thread. Lastly, the invention includes a method to auto-confirm to message senders on each thread to ensure that critical messages have been received by the agent.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL FIELD

Related technical field(s) are: telecommunications, digital communication, basic communication processes, and computer technology.

### BACKGROUND ART

The popularity of Short Message Service (SMS) or “text” messaging has exploded in recent years. By some estimates, its use is approaching the frequency of e-mail (in 2012, approx. 50 trillion e-mails vs. approx. 5-10 trillion text messages). The proliferation of easy-to-use mobile computing devices has certainly contributed to its adoption. While initially primarily a personal communication technology, businesses are increasingly interested in exploiting SMS for commercial communications. Popular examples are philanthropic organizations that can accept donations from users by text messages. In fact, SMS is rapidly becoming a preferred communication method for many mobile device users.

However, text messaging is not without its limitations. Most commercial carriers do not permanently store messages on behalf of their users and therefore there is little to no record keeping capability. There is simply too much data to justify the cost of indefinite persistent storage in the absence of significant consumer demand. Instead, SMS messages have (historically) been stored on the recipient's mobile device. Modernly, the sender's device also typically retains a copy. However, these records are fragile, as they are lost if the device is lost or destroyed.

Increasingly, companies are offering services to introduce more of the advancements of e-mail (e.g. cloud storage, web interfaces, threading) to text messaging. For example, Google Voice provides (among other things) a hosted service which is capable of sending and receiving SMS text messages via e-mail or a web interface. An increasing number of customer relationship management (CRM) systems have SMS gateways to send or receive text messages.

However, these systems are not well suited to environments where very short response times are required or expected because they all rely on user intervention to maintain timeliness of response. A unified system that aggregates messages from any source is far better suited for real time response because the sender can transmit using any method available and the receiver will receive in one aggregated interface. For example, emergency service dispatchers and first responders may benefit from increasingly rich data associated with text messages. Emergency service personnel need detailed record keeping that includes the identity of the sender, the location of the sender, any Multimedia Messaging Service (MMS) attachments, and they need near real time response. Consequently, conventional SMS services are ill suited to emergency services applications.

Another example is customer service. Consumers have grown to expect highly interactive environments in which to resolve issues. Traditionally this has been done with voice calls, but increasingly, consumers expect real time, web-based instant messaging (IM) or “chat” features to be provided for interfacing with customer service personnel. These solutions demand both record keeping and real time aspects to them that are not present with conventional text messaging.

In both of the example application domains illustrated here, emergency service dispatch and customer service, the agent receiving the messages must forward the incoming messages to an appropriate agency for action. A message to emergency dispatch concerning an auto accident with injuries, for example, would be forwarded to paramedics, police, and possibly auto towing services.

What is needed is a system that merges the benefits of e-mail (including threading) and instant messaging as well as new features to SMS/MMS in order to provide near real time interaction with consumers with support for persistent record keeping as well as auto-forwarding necessary for businesses and other organizations.

### SUMMARY OF THE INVENTION

The invention pertains to two-way, real time communication incorporating any type of messaging (e,g, SMS, MMS, e-mail, hereafter referred to as “messaging”) and a web browser interface with persistent record keeping and auto-forwarding. A user (agent) accessing the web interface communicates in real time with another user (client) the sending and receiving of messages. The messaging is automatically threaded and stored for later search and retrieval and it is automatically forwarded to an agency as required by the client and the content of the message.

When a message is received from a client, an auto-reply message is sent to the client confirming receipt (FIG. 1). The message is recorded in a data store along with the client's information that includes identity, location, and number. A unique identifier is assigned to the message for the purpose of record keeping and threading of any follow-on messages that may arrive later. If no message has been received from this number within a specified time period, then the message is considered a new thread and an auto-reply message is sent to the sender to verify that the original message was received. This auto-reply message is delivered only once per thread. All subsequent messages of any type that follow the initial message (i.e. they arrive within the specified time period) are considered part of the original thread. All messages are sent to the appropriate agency with a link to allow retrieval and reply.

If the message is a photo message or other MMS type (FIG. 2), the process is similar. The system first identifies if the message with multimedia attachments has been sent to a generic e-mail address or to a specific address which indicates that it is part of an ongoing thread. A client will typically use a generic address (similar to “911” for voice) to initiate a new thread, otherwise a specific address is used. If the sender cannot be identified, then the system will assign a unique identifier, mark the message as new, and flag the message as including media. If the sender can be identified, then the message is joined to the existing thread. As described, the system will send an auto-reply if this is the first message, it will add the message to the data store, and it will forward a link to the appropriate agency for retrieval or reply.

The agent (e.g. a dispatcher, operator, customer service representative) authenticates himself or herself via an interface to start a session (FIG. 3). When the message is received, a message is displayed in the agent's session, for example, in a list or queue of messages, where new messages are visually distinguished from other messages. The agent views all threads within a history pane in a web browser. The agent can open each thread to view the history of that dialog. The messages contained therein may be of any type. The agent can choose predefined responses (e.g. “Medical assistance on its way.”) for efficiency or the agent may reply manually. The agent's responses are always associated with the current thread and are added to the data store. If the agent requests a photo or other media from the client, a message with a link is sent to the client. The client uses that link to capture the image and reply to the agent which then adds it to the thread and the data store. If an incoming message is not responded to in a specific period of time, the agent is alerted until the message is answered or the alert is explicitly dismissed.

As long as the criteria are met, the agent's responses and client's replies are threaded into a list of related messages regardless of the types of messages they may be. As non-limiting examples, threading criteria could include: identification of the client, content of the message (e.g. inclusion of a phrase or a reference number), or time since the last message was sent or received. It is typical, although not required, that each “volley” consists of one message in either direction. However, it is possible that an agent sends several responses to a client's message before receiving a reply, or that a client sends several messages before an agent sends a response.

Incoming messages that are part of a thread, but to which there has been no response (or other action) by an agent after a preset time, are marked as “new” and identified as such (e.g. for other agents to view and respond to). Other agents may be “locked out” or prevented from seeing the thread, or blocked from interacting with the client after one agent views or replies to the first incoming message. Alternatively, some agents may be locked out, but others may be able to view, and still others may be able to participate. These abilities may be associated with specific agents or general roles or groups and may be configurable by an administrator. For example, a customer service agent may be excluded from viewing or participating in other threads, but a trainee may be permitted to view threads, while a supervisor may be able to view and participate in threads handled by other agents.

Where no response by an agent is necessary to a client's message, agents are provided a means to “clear” the message. Depending on what other features are provided, this could, for example, remove the “new” designation from the client's message, or it may maintain control or assignment of the thread to a particular agent. An agent could further clear the message as preventing further alerts in that thread for that agent, or for other agents (e.g. where a client engages in inappropriate behavior).

The interface provides for interaction with more than one thread by the agent (e.g. in different panes or windows). The interface allows the agent to monitor the queue of incoming messages while interacting with existing threads. If enabled, alerts may appear associated with any thread or incoming queue simultaneously. Receipt of messages in various threads and the incoming queue do not “block” the interface or prevent messages from being displayed in other threads or the incoming queue.

### BRIEF DESCRIPTION OF THE DRAWINGS

FIG. 1 is a block diagram depicting receipt of a client's SMS message.

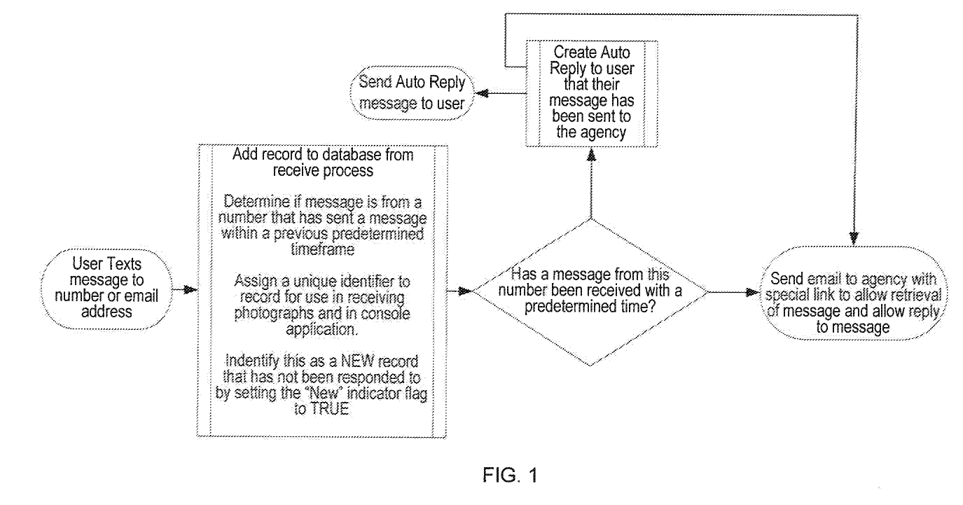

FIG. 2 is a block diagram depicting receipt of a client's MMS message.

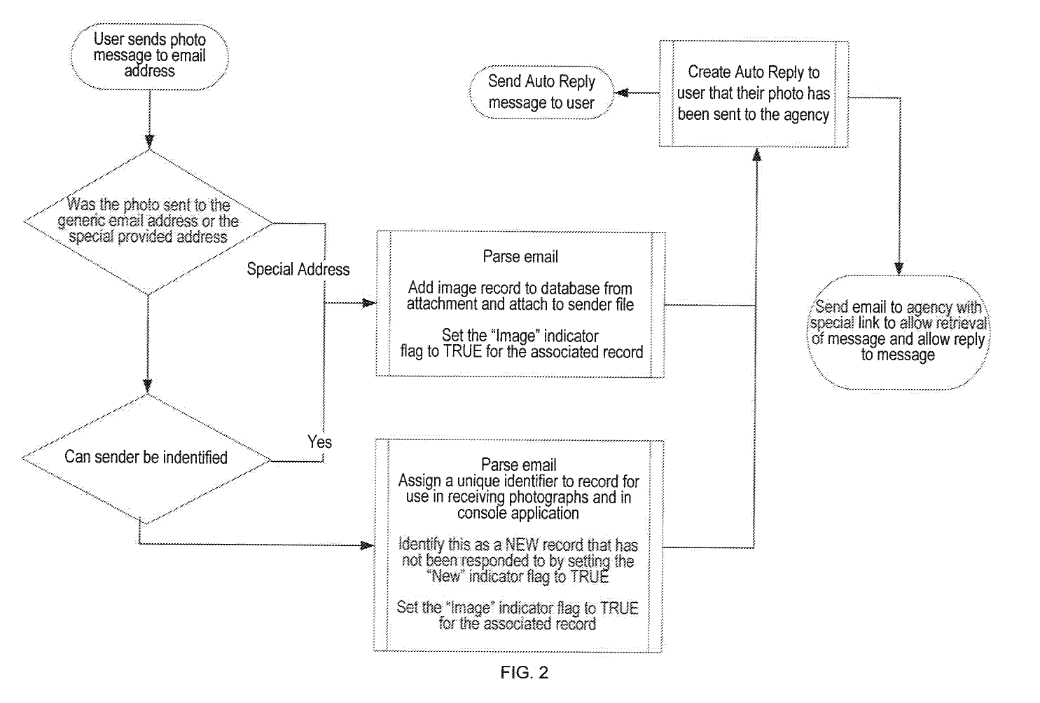

FIG. 3 is a block diagram depicting interaction with a client sending and receiving e-mail messages, which optionally include multimedia attachments or other embedded data.

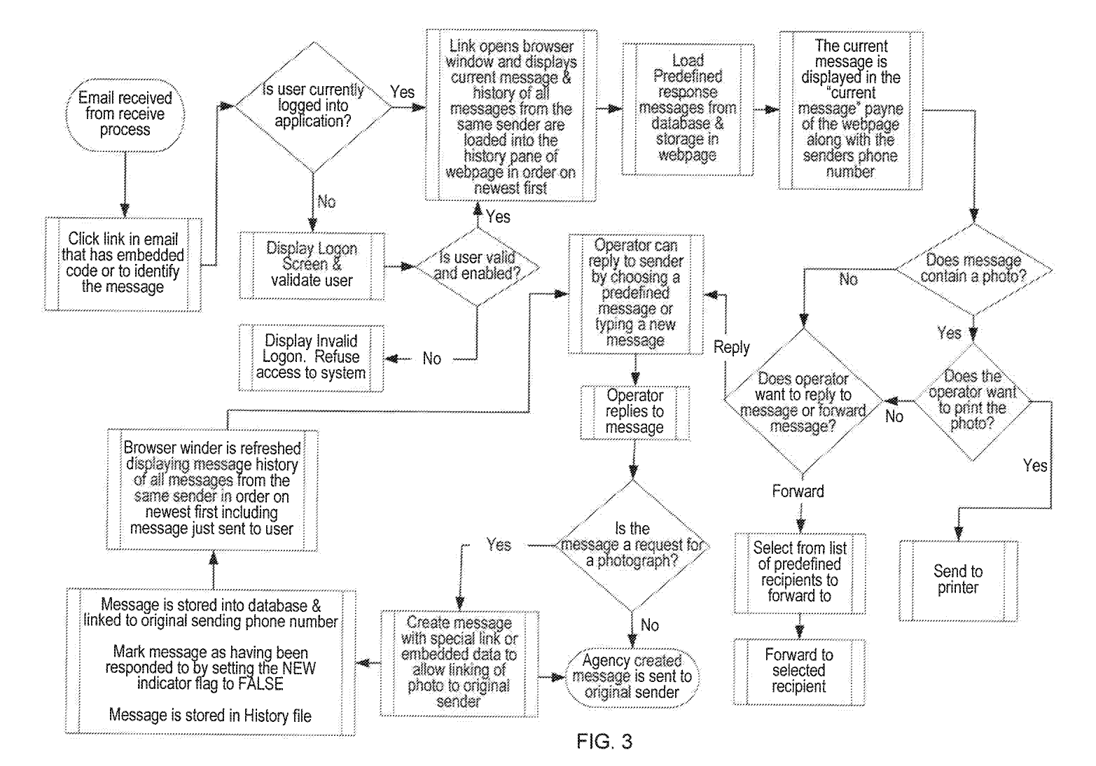

### INDUSTRIAL APPLICABILITY

The invention pertains to emergency services and dispatch, customer service, as well as any industry where managed real time communication with record keeping may be of value or importance.

What is claimed is:

1. A system for real time communication between an agent and a client comprising:
a message receiving interface for receiving incoming messages from the client;
a message sending interface for sending outgoing messages to the client from the agent, said incoming and outgoing messages being threaded for associating prior incoming and outgoing messages related to the initial message;
an interactive display for displaying the received messages from the client and the sent messages from the agent in real time, said interactive display is configured to depict which messages are associated with which other messages; and
a data store for automatically storing in persistent memory the threaded incoming and outgoing messages.

2. The system of claim 1, where the message receiving interface is for receiving SMS messages, and the message sending interface is for sending SMS messages.

3. The system of claim 1, where the message receiving interface is for receiving MMS messages, and the message sending interface is for sending MMS messages.

4. The system of claim 1, where the message receiving interface is for receiving e-mail messages, and the message sending interface is for sending e-mail messages.

5. The system of claim 1, where the sender of a new incoming message receives an automatically generated confirmation reply.

6. The system of claim 1, where messages pertaining to a specific agency or third party are automatically forwarded to that agency or third party.

7. A method for real time communication between an agent and a client comprising the steps:
receiving an incoming message from the client;
sending a response from the agent;
threading associated incoming and outgoing messages with prior incoming and outgoing messages related to the initial message;
displaying for the agent in real time the incoming messages from the client, and the outgoing messages from the agent; and
storing in persistent memory the threaded incoming and outgoing messages.

8. The method of claim 7, where the incoming message is a SMS message, and the outgoing message is a SMS message.

9. The method of claim 7, where the incoming message is a MMS message, and the outgoing message is a MMS message.

10. The method of claim 7, where the incoming message is an e-mail message, and the outgoing message is an e-mail message.

11. The method of claim 7, where the sender of a new incoming message receives an automatically generated confirmation reply.

12. The method of claim 7, where messages pertaining to a specific agency or third party are automatically forwarded to that agency or third party.
